(19) United States
(12) Patent Application Publication
(10) Pub. No.: US 2021/0259065 A1
(43) Pub. Date: Aug. 19, 2021

(54) HOB DEVICE

(71) Applicant: BSH Hausgeräte GmbH, Munich (DE)

(72) Inventors: Carlos Franco Gutierrez, Zaragoza (ES); Teresa Del Carmen Marzo Alvarez, Zaragoza (ES); David Paesa Garcia, Zaragoza (ES); Maria Parra Borderías, Zaragoza (ES); Agostina Rodriguez Larrosa, Zaragoza (ES); Beatriz Villanueva Valero, Zaragoza (ES)

(21) Appl. No.: 17/252,755

(22) PCT Filed: Jun. 7, 2019
(86) PCT No.: PCT/IB2019/054753

§ 371 Date: Dec. 16, 2020

(30) Foreign Application Priority Data
Jun. 21, 2018 (ES) P201830625

(51) Int. Cl. H05B 6/12

(52) U.S. Cl. CPC H05B 6/1209; H05B 2213/06

(57) ABSTRACT

A cooking device includes an information unit having an information storage unit for storing an intrinsic placement unit characteristic of a placement unit which is placeable on a cooking surface so as to be heatable. The information unit is arranged on the placement unit outside of a heating region of the placement unit for communication with a communication unit.

The invention relates to a cooking device as claimed in the preamble of claim 1 and a method for operating a cooking device as claimed in claim 13.

A cooking device which has an information unit comprising an information storage unit has already been disclosed in international patent application WO 01/19141 A1. An intrinsic placement unit characteristic of a placement unit, which is configured as a pan, is stored in the information storage unit. The intrinsic placement unit characteristic of the placement unit stored in the information storage unit is a type of placement unit. The information unit is unreleasably and fixedly integrated in a base of the placement unit. The base of the placement unit defines a heating region of the placement unit which is why the information unit is arranged in the heating region of the placement unit.

The object of the invention, in particular, is to provide a generic device with improved properties regarding flexibility. The object is achieved according to the invention by the features of claims 1 and 13, while advantageous embodiments and developments of the invention may be derived from the subclaims.

The invention is based on a cooking device, in particular an induction cooking device, comprising at least one information unit that has at least one information storage unit in which at least one intrinsic placement unit characteristic of at least one placement unit provided for placing on at least one cooking surface for the purposes of heating can be stored.

It is proposed that the information unit is designed to be arranged on the placement unit outside of a heating region of the placement unit for the purpose of communicating, in particular wirelessly, with at least one communication unit.

By means of such an embodiment, in particular, a high level of flexibility may be achieved. By the arrangement of the information unit outside of the heating region of the placement unit, in particular, a low thermal load of the information unit and/or a durable embodiment may be possible. In particular, by the intrinsic placement unit characteristic which may be stored in the information storage unit, advantageously a food preparation process and/or a food preparation result may be optimized, and namely in particular for any design of placement unit. Since, in particular, each user has different expectations and/or requirements and/or experiences, in particular by storing the intrinsic placement unit characteristic in the information storage unit, the user may be, in particular, specifically and/or individually catered for, whereby advantageously a high level of user convenience and/or a high level of user satisfaction may be possible.

A “cooking device”, in particular an “induction cooking device”, is intended to be understood, in particular, as a device which is provided, in particular, for a use and/or for an application with at least one hob and/or with at least one hob object and/or with at least one hob accessory object. A “hob object” is intended to be understood, in particular, as at least one part, in particular a subassembly, of a hob, in particular of an induction hob. A “hob accessory object” is intended to be understood, in particular, as an object which is provided, in particular, for a use and/or for an application with at least one hob and/or which is configured, in particular, as an accessory for at least one hob.

At least one hob object could be, for example, at least one control unit and/or at least one user interface and/or at least one hob housing unit and/or at least one hob heating unit and/or at least one inverter and/or at least one placement plate configured as a hob plate and/or at least one extractor unit and/or at least one hob electronics unit. For example, at least one hob accessory object could be a sensor unit for the external measurement of a temperature of a food preparation vessel and/or an item of food to be prepared and/or a placement unit. Alternatively or additionally, at least one hob accessory object could be, for example, a food preparation vessel and/or a placement unit and/or a contact module which, in particular, could be provided for an arrangement on the food preparation vessel and/or on the placement unit. In particular, alternatively or additionally at least one hob accessory object could be an adapter which could be provided, in particular, for coupling to at least one kitchen object and, in particular, for placing and/or positioning on the placement plate.

Preferably, the cooking device is a device which is provided for a releasable arrangement on at least one placement unit, in particular without the use of tools. The cooking device is provided, in particular, for coupling to at least one placement unit. In at least one operating state the cooking device is connected, in particular, by a non-positive and/or positive and/or material connection to the placement unit and, in particular, is arranged on the placement unit.

An “information unit” is intended to be understood, in particular, as a unit which in at least one operating state is provided, in particular, for storing at least one placement unit characteristic having at least one item of information, and/or which in at least one operating state is provided, in particular by means of the placement unit characteristic, for supplying at least one placement unit characteristic having, in particular, at least one item of information.

The expression that at least one characteristic is “storable” in the information storage unit of the information unit is intended to be understood, in particular, to mean that in at least one operating state the characteristic is advantageously actively transmitted to the information unit, in particular to the information storage unit, in particular manually and/or by at least one user input by means of the user interface and/or by receiving from at least one external electronics unit, and in particular may be stored in the information storage unit and/or that the characteristic is stored in the information storage unit in a predefined and/or predetermined and/or preset manner. The predefined and/or predetermined and/or preset characteristic is stored in the information storage unit, in particular in the factory, for example by a mechanic and/or by a technician and/or during the course of a manufacture of the information unit, and namely, in particular, before starting at least one operating state. The mechanic and/or the technician differs, in particular, from a user. In particular, at least one characteristic in at least one operating state is able to be stored and/or deposited in the information storage unit and namely in particular manually and/or by at least one user input by means of the user interface and/or by receiving from at least one external electronics unit. The external electronics unit could be, for example, a mobile device and/or a network. The mobile device could be, for example, a cell phone and/or a tablet and/or a laptop and/or a mobile telephone. The network could be, for example, a household network and/or a global network and/or a regional network and/or a network inside a building.

In particular alternatively or additionally, in particular to the storable characteristic, in particular at least one characteristic could be stored in the information storage unit in a preset manner and/or in the factory. For example, at least one characteristic could be stored in the information storage unit in the factory and/or in a preset and/or predefined manner. A “user input” is intended to be understood, in particular, as an optical and/or acoustic input by means of the user interface, in particular by a user.

An “intrinsic” placement unit characteristic of a placement unit is intended to be understood, in particular, as a placement unit characteristic which is inherent in the placement unit and/or characterizes the placement unit and namely, in particular, irrespective of an operating state and/or of a placement position of the placement unit. “Intrinsic” is intended to be understood, in particular, as inherent and/or of its own accord and/or having by itself and/or without having external influence and/or without having external effect.

A “placement unit characteristic” of a placement unit is intended to be understood, in particular, as a characteristic which characterizes the placement unit and/or which is assigned to the placement unit. In particular, the placement unit characteristic differs from a characteristic which, in particular, is dependent on at least one operating state and/or on at least one placement position. The placement unit characteristic differs, in particular, from a temperature and/or from a food preparation state and/or from a placement position and/or from a number of hob heating units which heat the placement unit and/or from a heating zone which is assigned, in particular, to the placement unit.

For example, at least one placement unit characteristic could be a geometric characteristic. The geometric characteristic could be, for example, a shape and/or a design and/or a height and/or a diameter and/or a weight. Alternatively or additionally, at least one placement unit characteristic could be a suitability characteristic. The suitability characteristic could, for example, be a material, in particular of a heating region of the placement unit to be heated, and/or a type and/or a color, in particular, of a heating region of the placement unit to be heated. A suitability characteristic which is a type could be, for example, a pot and/or a pan and/or a steam cooking appliance and/or a wok and/or a teppanyaki plate and/or a roasting device and/or a grill device.

In particular, at least one placement unit characteristic could be instructions for use and/or a preferred food preparation process and/or a preferred cooking process and/or a preferred food preparation type and/or a preferred cooking type. At least one placement unit characteristic could be, in particular, a suitability of the placement unit for at least one sensor function and/or for at least one food preparation process and/or for at least one cooking process and/or for at least one food preparation type and/or for at least one cooking type. In particular, at least one placement unit characteristic could be a result stored, in particular in a predefined manner, of a calibration of the placement unit having at least one hob heating unit.

At least one placement unit characteristic could be, in particular, at least one general and/or generic instruction and/or at least one general and/or generic item of information relative to the placement unit, such as for example at least one item of information and/or at least one instruction relative to a food preparation type and/or relative to a cooking type and/or relative to a suitability for an arrangement of at least one communication unit and/or relative to a cleaning of the placement unit and/or relative to a maintenance of the placement unit.

A “placement unit” is intended to be understood, in particular, as a unit which is provided for placing and/or positioning on a placement plate and namely, in particular, for the purpose of heating at least one part of the placement unit. The placement unit could have, for example, at least one cooking vessel element and/or at least one food preparation vessel. Alternatively or additionally, the placement unit could have at least one pad unit which could be provided, in particular, for placing at least one cooking vessel element, in particular the cooking vessel element, and/or at least one food preparation vessel, in particular the food preparation vessel. The pad unit could be provided, for example, in at least one operating state for an arrangement between a cooking vessel element to be heated and/or food preparation vessel of the placement unit and the placement plate. In particular, at least one object of the placement unit, in particular a plurality of objects of the placement unit, and advantageously all of the objects of the placement unit could be integrated at least partially and advantageously at least to a large extent in the pad unit.

Alternatively, in particular for the embodiment in which the placement unit has at least one pad unit and, in particular, at least one cooking vessel element and/or at least one food preparation vessel, the placement unit could have, for example, at least one housing unit which, in particular, could be configured as an external placement unit housing and, in particular, could form an external housing of the placement unit at least to a large extent. In particular, at least one object of the placement unit, in particular a plurality of objects of the placement unit and advantageously all of the objects of the placement unit, could be integrated at least partially and advantageously at least to a large extent in the housing unit.

The object of the placement unit could be, in particular, at least one electrical and/or electronic object. At least one object of the placement unit could be, for example, a placement user interface and/or a placement control unit and/or a placement sensor unit and/or a placement transmission unit. “At least to a large extent” is intended to be understood, in particular, as a portion, in particular a mass portion and/or volume portion of at least 70%, in particular of at least 80%, advantageously of at least 90% and preferably of at least 95%.

In particular, a cooking system having the cooking device has at least one placement plate. The placement plate is provided, in particular, for placing and/or for positioning at least one placement unit and/or for positioning at least one item of food to be prepared. A “placement plate” is intended to be understood, in particular, as at least one, in particular plate-like, unit which is provided for placing at least one placement unit and/or for positioning at least one placement unit and/or for placing at least one food preparation vessel and/or for positioning at least one item of food to be prepared for the purpose of heating. The placement plate could be configured, for example, as a partial region of at least one worktop, in particular at least one kitchen worktop, in particular of the cooking system. Alternatively or additionally, the placement plate could be configured as a hob plate. The placement plate configured as a hob plate could form, in particular, at least one part of an external hob housing and, in particular together with at least one hob housing unit configured as an external housing unit, to which the placement plate configured as hob plate could be connected in at least one mounted state, could form, in particular, at least one external hob housing at least to a large extent. The placement plate could be made, for example, at least to a large extent from glass and/or from glass ceramic and/or from Neolith and/or from Dekton and/or from wood and/or from marble and/or from stone, in particular from natural stone and/or from laminate and/or from metal and/or from plastic and/or from ceramics.

The placement plate defines and/or delimits at least one cooking surface which is provided, in particular, for placing at least one placement unit and/or for positioning at least one placement unit and/or for placing at least one food preparation vessel and/or for positioning at least one item of food to be prepared for the purpose of heating. In particular, the cooking surface is configured as a partial surface region of the placement plate, below which in an installed position at least one hob heating unit is arranged. In particular, the cooking system has the hob heating unit which is configured, in particular, as an induction hob heating unit.

The communication unit, in particular, is part of the cooking system. In particular, the cooking system has at least one, in particular the, communication unit. A “communication unit” is intended to be understood, in particular, as a unit which, in particular, has at least one receiving unit which is provided, in particular, for receiving at least one item of information and/or at least one signal from at least one further unit and, in particular, at least one transmitting unit which is provided, in particular, for transmitting at least one item of information and/or at least one signal to at least one further unit and which, in particular by means of the receiving unit and/or the transmitting unit, is provided in particular for a communication with at least one further unit. In particular, the communication unit is provided, in particular by means of the receiving unit and/or the transmitting unit, in particular for an exchange of at least one item of information and/or at least one signal with at least one further unit and/or for an interaction with at least one further unit. A “communication” is intended to be understood, in particular, as an exchange and/or an interaction and/or a contact and/or notification.

The cooking system has, in particular, at least one, in particular the, further unit. At least one further unit could be, for example, a mobile device and/or a hob and/or a contact module and/or a network. Alternatively or additionally, at least one further unit could be, in particular, at least one application, in particular at least one mobile application.

The phrase that an object is provided for an “arrangement on at least one placement unit” is intended to be understood, in particular, to mean that the object in at least one operating state is arranged on at least one wall, in particular a side wall, of the placement unit and/or on at least one cover of the placement unit and/or inside the placement unit and/or on at least one handle element of the placement unit. In particular, the object arranged on the wall of the placement unit and/or on the cover of the placement unit is arranged in direct contact with the placement unit. For example, the object could be arranged in direct contact with the placement unit by at least one suction element and/or by at least one mechanical connection with the placement unit and/or by at least one magnet. In particular, the object arranged inside the placement unit is arranged in a receiving space configured by the placement unit and, in particular, is surrounded by the placement unit on at least one plane over an angular range of at least 180°, advantageously of at least 270° and preferably of at least 330°.

In particular, the information unit and/or the communication unit is provided to be arranged at least in one operating state so as to be removable, in particular reusable, on the placement unit, in particular on at least one side wall of the placement unit.

In particular, the information unit and/or the communication unit could be configured at least to a large extent from plastic, in particular from plastic with low thermal conductivity. For example, the information unit and/or the communication unit could be configured at least to a large extent from silicone with low thermal conductivity. In particular, the information unit and/or the communication unit, when viewed perpendicular to a main extension plane of the information unit and/or the communication unit, could be configured to be oval-shaped, for example elliptical and advantageously circular. Alternatively or additionally, the information unit and/or the communication unit could be configured to be band-shaped and/or strip-shaped. A “low” thermal conductivity is intended to be understood, in particular, as a thermal conductivity having a value of a maximum of 10 W/(m·K), in particular of a maximum of 1 W/(m·K), advantageously of less than 0.5 W/(m·K), particularly advantageously of a maximum of 0.2 W/(m·K) and preferably of a maximum of 0.1 W/(m·K).

In particular, the information unit and/or the communication unit has a thickness of a maximum of 40 mm, in particular of a maximum of 30 mm and advantageously of a maximum of 20 mm. In particular, the information unit and/or the communication unit, when viewed perpendicular to a main extension plane of the information unit and/or the communication unit, has a diameter of a maximum of 40 mm, in particular of a maximum of 35 mm and advantageously of a maximum of 30 mm. In particular, the information unit and/or the communication unit, when viewed perpendicular to a main extension plane of the information unit and/or the communication unit, has a diameter of at least 5 mm, in particular of at least 7 mm and advantageously of at least 10 mm. A “thickness” of an object is intended to be understood, in particular, as a shortest extent of a smallest imaginary geometric cuboid which only just completely encloses the object.

A “heating region” of a placement unit is intended to be understood, in particular, as a partial region of the placement unit which is provided for heating and/or which is provided, in particular, in at least one operating state to receive heating energy and, in particular, to conduct received heating energy at least partially and advantageously at least to a large extent, in particular, to at least one item of food arranged inside the placement unit. In particular, the placement unit at least in the heating region is configured at least to a large extent from at least one ferromagnetic material and/or from at least one, in particular inductively, heatable material. In at least one operating state the heating region is configured, in particular, as a partial region of the placement unit facing the hob heating unit and/or the placement plate and/or is arranged at least to a large extent between at least one food receiving space of the placement unit and the hob heating unit and/or the placement plate.

The expression that an object is provided for an arrangement “outside” of a region of a unit is intended to be understood, in particular, to mean that the object in at least one operating state is arranged spaced apart from the region of the object and/or that the object in at least one operating state is arranged in a further region of the object which is different from the region. The object is, in particular, the information unit and/or the communication unit.

The object, in particular the information unit and/or the communication unit, in at least one vertical direction which is oriented in particular perpendicular to at least one main extension plane of the placement plate, is arranged in particular spaced apart from the heating region of the placement unit. The object, in particular the information unit and/or the communication unit, in at least one operating state is arranged relative to the vertical direction, in particular, at a distance of at least 1 cm, in particular of at least 2 cm, advantageously of at least 3 cm, particularly advantageously of at least 5 cm, preferably of at least 7 cm and particularly preferably of at least 10 cm spaced apart from the heating region of the placement unit. In particular the object, in particular the information unit and/or the communication unit, in at least one operating state is arranged spaced apart from the heating region of the placement unit, relative to the vertical direction, in particular, at a distance of at least 2 times, in particular of at least 4 times, advantageously of at least 6 times, particularly advantageously of at least 10 times, preferably of at least 15 times and particularly preferably of at least 20 times a material thickness of the base and/or the heating region of the placement unit. In particular the object, in particular the information unit and/or the communication unit, in at least one plane which is oriented in particular perpendicular to at least one main extension plane of the placement plate, is arranged without overlapping the base and/or the heating region of the placement unit.

In particular the object, in particular the information unit and/or the communication unit, is arranged without overlapping the heating region of the placement unit in at least one horizontal direction which is oriented, in particular, parallel to at least one main extension plane of the placement plate. For example, the object, in particular the information unit and/or the communication unit could be adjoined, in particular, directly to the heating region of the placement unit, relative to the horizontal direction. Alternatively or additionally, the object, in particular the information unit and/or the communication unit, could be arranged, in particular, spaced apart from the heating region of the placement unit, relative to the horizontal direction. A spacing between the object, in particular the information unit and/or the communication unit, and the heating region of the placement unit could be defined and/or predetermined, for example, by at least one material thickness of at least one side wall of the placement unit.

“Provided” is intended to be understood, in particular, as specifically programmed, designed and/or equipped. An object being provided for a specific function is intended to be understood, in particular, as the object fulfilling and/or performing this specific function in at least one use state and/or operating state.

For example, the information unit could be provided for a releasable arrangement on the placement unit only by the use of tools and/or for an arrangement on the placement unit by a material connection and/or for an integration in the placement unit. Particularly advantageously, the information unit is provided for an arrangement on the placement unit by a non-positive and/or positive connection. Preferably, the information unit is provided for a releasable arrangement on the placement unit without the use of tools. As a result, in particular, a high level of flexibility may be achieved since the information unit may be arranged at any point, in particular, of the placement unit outside of the heating region of the placement unit.

The information unit could be provided, for example, for an arrangement at least on a handle element of the placement unit and/or on at least a cover of the placement unit. Preferably the information unit is provided for an arrangement at least on a side wall of the placement unit. In particular, in at least one operating state the information unit has on a partial region facing the side wall at least in some portions a design which is adapted to a shaping of the side wall. A “side wall” of a placement unit is intended to be understood, in particular, as a wall which defines and/or forms an outer boundary of the placement unit. In particular, the side wall of the placement unit, in at least a direction which is oriented perpendicular to a main extension plane of a base of the placement unit, protrudes above the base of the placement unit by at least an extent of at least 2 times, in particular of at least 4 times, advantageously of at least 6 times, particularly advantageously of at least 10 times, preferably of at least 15 times, and particularly preferably of at least 20 times a material thickness of the base and/or the side wall. The side wall is oriented, in particular, at an angle to the base of the placement unit. In particular, the side wall in at least one cross-sectional plane which is oriented in particular at least substantially perpendicular to a main extension plane of the base of the placement unit, adjoins at least one in particular lateral and/or outer edge of the base in the cross-sectional plane. A “base” of a placement unit is intended to be understood, in particular, as a wall which, in particular in at least one operating state in which the placement unit is placed in particular on the placement plate, defines and/or forms a partial region of the placement unit which faces and/or is closest to the placement plate. The base of the placement unit, in particular in at least one operating state in which the placement unit is placed in particular on the placement plate, is arranged at least in some portions in contact with the placement plate. As a result, in particular, an easy accessibility of the information unit may be possible in an operating state, whereby in particular an uninterrupted communication of the information unit with the communication unit may be provided and namely, in particular, irrespective of an operating state.

It is further proposed that in at least one operating state the information unit has a concave design at least in some portions on at least a surface facing the side wall. “Concave” is intended to be understood, in particular, as inwardly curved. The phrase that the surface of the information unit has a specific design “at least in some portions”, is intended to be understood, in particular, to mean that the surface of the information unit has at least one portion which has the specific design and, in particular in addition to the portion, could have at least one further portion which could have a design which is different from the specific design. For example, the surface of the information unit could have a planar design and/or a convex design in the further portion. In particular, the portion of the surface of the information unit which, in particular, faces the side wall in the operating state and which, in particular, has the concave design, is arranged at least partially, advantageously at least to a large extent and preferably entirely, inside a smallest imaginary geometric cuboid which only just completely encloses the information unit. The portion of the surface of the information unit which, in particular, faces the side wall in the operating state and which, in particular, has the concave design, is curved in particular in the direction of a central point and/or geometric center of gravity of the information unit. As a result, the information unit may be arranged, in particular, optimally and/or by a positive connection on the side wall, whereby in particular a secure connection between the side wall and the information unit may be possible and/or the presence of corners and edges which could entail, in particular, a high risk of injury, may be avoided.

For example, the information unit could be provided for communication with the communication unit by means of electromagnetic radiation and/or by means of radio. Alternatively or additionally, the information unit could be provided, in particular, for inductive communication with the communication unit. The information unit could be provided, in particular, for a communication with the communication unit in the radio frequency range. Preferably, the information unit is provided for a communication with the communication unit by means of at least one near field communication technology. The information unit has, in particular, at least one information receiving unit which is provided, in particular, for receiving at least one item of information and/or at least one signal from the communication unit and, in particular, at least one information transmitting unit which, in particular, is provided for transmitting at least one item of information and/or at least one signal to the communication unit. In particular, the information receiving unit and/or the information transmitting unit is specifically provided and/or is suitable and/or designed and/or programmed for a communication by means of a near field communication technology. The information unit, in particular by means of the information receiving unit and/or the information transmitting unit, is provided in particular for a communication with the communication unit. In particular, the information unit, in particular by means of the information receiving unit and/or the information transmitting unit, is provided in particular for exchanging at least one item of information and/or at least one signal with the communication unit and/or for an interaction with the communication unit. As a result, in particular over short distances, in particular a high quantity of information and/or data may be transmitted and/or an optimized communication may be possible.

For example, at least a large proportion and advantageously all of the intrinsic placement unit characteristics are storable in the information storage unit. In particular, the information storage unit could be free of intrinsic placement unit characteristics stored in the information storage unit in the factory and/or in a predefined and/or predetermined manner. Preferably at least one intrinsic placement unit characteristic is stored in a predefined manner in the information storage unit. In particular, at least one intrinsic placement unit characteristic of at least one placement unit, which is in particular common and/or widely used, could be stored in the information storage unit in order to ensure already the least possible effort, in particular, for a plurality of customers and/or users and/or, in particular for standard placement units, in order to be able to avoid an input of at least one intrinsic placement unit characteristic. As a result, in particular during initial operation, low effort on the part of a user and/or a high level of user convenience may be possible, since a user may have recourse, in particular, to already stored intrinsic placement unit characteristics.

For example, at least a large proportion and advantageously all of the intrinsic placement unit characteristics could be stored in a predefined manner in the information storage unit. Preferably, the information unit is provided for receiving at least one intrinsic placement unit characteristic from at least one further unit for the purpose of storing the received placement unit characteristic in the information storage unit. In particular, the information unit is provided for receiving at least one intrinsic placement unit characteristic by means of the information receiving unit. Alternatively or additionally, the information unit is provided for receiving at least one intrinsic placement unit characteristic by at least one user input, by means of at least one user interface. The user interface could be, for example, a hob user interface and/or an information user interface and/or a mobile device user interface. As a result, in particular, a high level of flexibility may be achieved since it may be possible for a user to store in the information storage unit, in particular, at least one placement unit characteristic for, in particular, any placement units.

It is further proposed that at least one placement unit characteristic configured as a geometric characteristic is storable in the information storage unit. The cooking system has, in particular, at least one control unit which is provided, in particular, to process at least one placement unit characteristic configured as a geometric characteristic. In particular, the control unit is provided to form, as a function of the placement unit characteristic configured as a geometric characteristic, at least one heating zone for the placement unit which, in particular, has the placement unit characteristic. The control unit is provided, in particular, to establish and/or to determine a heating power to be supplied to the placement unit as a function of the placement unit characteristic and namely, in particular, for the purpose of heating the placement unit with a target heating power. The target heating power could be predetermined, in particular, manually, for example by at least one user input by means of the user interface, and/or predefined for example by an automatic food preparation program. In particular, the target heating power is a heating power to be achieved. As a result, in particular, an optimal heating may be possible of a placement unit having the placement unit characteristic configured as a geometric characteristic.

It is further proposed that at least one placement unit characteristic configured as a suitability characteristic is storable in the information storage unit. The control unit is provided, in particular, to process at least one placement unit characteristic configured as a suitability characteristic. In particular, as a function of the placement unit characteristic configured, in particular, as a suitability characteristic, the control unit is provided to release and/or to block a heating of the placement unit which has, in particular, the placement unit characteristic. As a result, in particular, each placement unit may be optimally heated and, in particular, independently of the placement unit characteristic configured as a suitability characteristic, whereby in particular optimal food preparation results and/or a high level of user satisfaction may be achieved.

A particularly high level of flexibility may be achieved, in particular, by a cooking system, in particular by the cooking system, comprising at least one cooking device according to the invention with the placement unit, on which the information unit is arranged in at least one operating state, and/or with the communication unit. In particular, the cooking system has the cooking device according to the invention. The cooking system, in particular in addition to the cooking device, could have in particular the placement unit, on which the information unit could be arranged in particular in at least one operating state, and/or the communication unit. For example, the cooking system, in particular in addition to the cooking device, could have at least one hob and/or at least one placement plate. The placement plate could be, for example, part of the hob. Alternatively or additionally, in at least one operating state the hob could be arranged at least to a large extent and advantageously entirely below the placement plate.

The communication unit could be integrated, for example, at least to a large extent in the hob. Alternatively or additionally, the communication unit could be integrated, in particular at least to a large extent, in at least one mobile device. Preferably, in at least one operating state the communication unit is arranged on the placement unit outside of the heating region of the placement unit and, in particular, configured as a contact module and/or integrated at least to a large extent in at least one contact module. As a result, in particular, a durable embodiment and/or an optimal accessibility of the communication unit may be possible, whereby in particular a high level of user convenience may be provided.

It is further proposed that the communication unit is provided for a releasable arrangement on the placement unit without the use of tools. In particular, the communication unit is provided for an arrangement at least on a side wall of the placement unit. In at least one operating state, the communication unit has a concave design at least in some portions, in particular, on at least a surface facing the side wall. In particular, the communication unit is provided for a communication with the information unit by means of at least one near field communication technology. As a result, in particular, a high level of flexibility may be achieved since, in particular, the communication unit may be arranged, in particular, at any point of the placement unit outside of the heating region of the placement unit.

A particularly high level of flexibility may be achieved, in particular, by a method for operating a cooking device according to the invention and/or a cooking system according to the invention in which, in particular, in at least one operating state at least one intrinsic placement unit characteristic is provided electronically.

The cooking device in this case is not intended to be limited to the above-described use and embodiment. In particular, for fulfilling a mode of operation described herein the cooking device may have a number of individual elements, components and units which differs from that cited herein.

Further advantages are disclosed in the following description of the figures. An exemplary embodiment of the invention is shown in the drawing. The drawing, the description and the claims contain numerous features in combination. The person skilled in the art will also consider the features expediently and combine them together to form further meaningful combinations.

In the drawings:

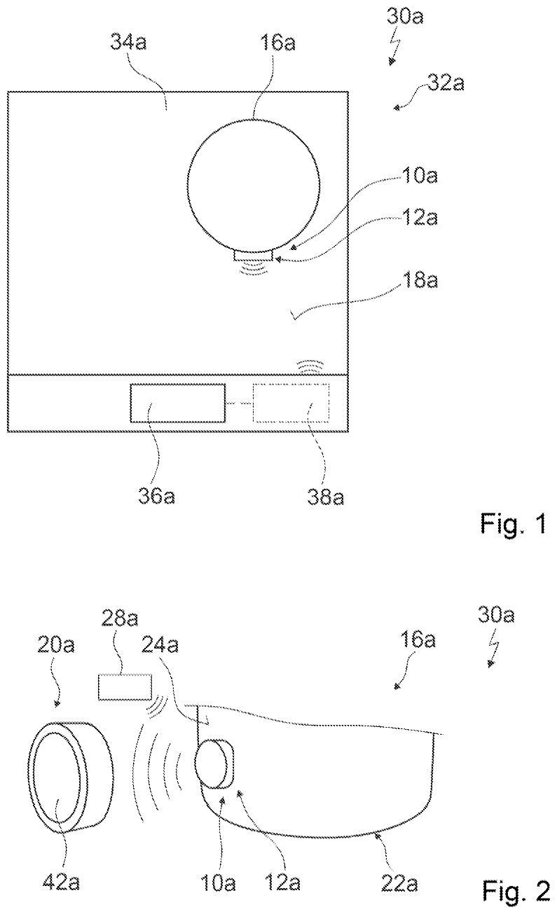

FIG. 1 shows a cooking system with a cooking device, with a hob, with a placement plate and with a placement unit on which an information unit of the cooking device is arranged, in a schematic plan view,

FIG. 2 shows the cooking system with the cooking device, with the placement unit, with a communication unit and with a further unit, in a schematic perspective view,

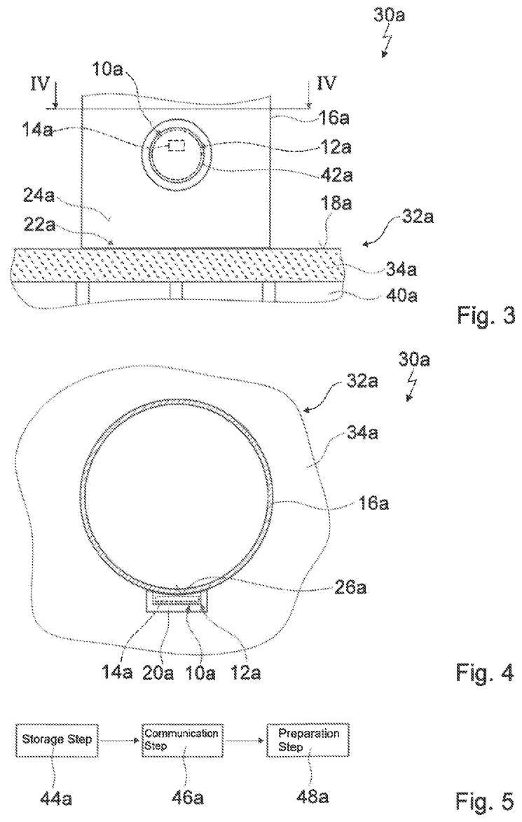

FIG. 3 shows the cooking system with the cooking device, with the hob, with the placement plate, with the placement unit and with the communication unit in a schematic sectional view in a cross-sectional plane which is oriented perpendicular to a main extension plane of the placement plate,

FIG. 4 shows the cooking system with the cooking device, with the hob, with the placement plate, with the placement unit and with the communication unit in a schematic sectional view along the line IV-IV in FIG. 3 and thus, in particular, in a cross-sectional plane which is oriented parallel to a main extension plane of the placement plate, and

FIG. 5 shows a diagram which shows method steps of a method for an operation of the cooking system and the cooking device, in a schematic view.

FIG. 1 shows a cooking system 30a which is configured as an induction cooking system, with a hob 32a which is configured as an induction hob.

The cooking system 30a has a placement plate 34a. In a mounted state the placement plate 34a forms a visible surface which in a mounted state is arranged, in particular, facing a user. The placement plate 34a is provided for placing a placement unit 16a for the purpose of heating the placement unit 16a. In the present exemplary embodiment, the placement plate 34a is configured as a hob plate.

The placement plate 34a defines a cooking surface 18a. The cooking surface 18a is configured as a surface of the placement plate 34a facing a user, below which in an operating state, in particular, at least one hob heating unit 40a is arranged (see FIG. 3).

The cooking system 30a has the placement unit 16a. The placement unit 16a is provided for placing on the cooking surface 18a for the purpose of heating the placement unit 16a.

The cooking system 30a has at least one hob heating unit 40a. In the present exemplary embodiment, the cooking system 30a has a plurality of hob heating units 40a. Alternatively, the cooking system 30a could have, for example, a smaller number of hob heating units 40a, such as for example just one hob heating unit 40a and/or at least two, in particular at least four, advantageously at least eight, particularly advantageously at least twelve and preferably a plurality of hob heating units 40a. The hob heating units 40a could be arranged, for example, in the form of a matrix. Only one of the hob heating units 40a is described hereinafter.

The hob heating unit 40a is arranged in an installed position below the placement plate 34a. The hob heating unit 40a is provided to heat at least one placement unit 16a placed on the placement plate 34a above the hob heating unit 40a. The hob heating unit 40a is configured as an induction hob heating unit. In the operating state, the hob heating unit 40a is arranged below the cooking surface 18a. The hob heating unit 40a of the cooking system 30a is part of the hob 32a. The hob 32a has the hob heating unit 40a of the cooking system 30a.

The cooking system 30a has a hob user interface 36a. The hob user interface 36a is provided for an input and/or selection of control parameters, such as for example a heating power and/or a heating power density and/or a heating zone. The hob user interface 36a is provided for an output of a value of a control parameter to a user.

The cooking system 30a has a hob control unit 38a. In the operating state, the hob control unit 38a controls and/or regulates a hob main function. The hob control unit 38a is provided to perform actions and/or change settings as a function of control parameters input by means of the hob user interface 36a. In the operating state, the hob control unit 38a regulates an energy supply to the hob heating unit 40a. The hob control unit 38a of the cooking system 30a in the present exemplary embodiment is part of the hob 28a. The hob 28a has the hob control unit 38a of the cooking system 30a.

The cooking system 30a has a cooking device 10a. The cooking device 10a is configured as an induction cooking device. In an operating state, the cooking device 10a is arranged on the placement unit 16a.

The cooking device 10a has an information unit 12a. In an operating state, the information unit 12a of the cooking device 10a is arranged on the placement unit 16a and namely, in particular, so as to be releasable without the use of tools. The information unit 12a is provided for a releasable arrangement on the placement unit 16a without the use of tools.

The information unit 12a has an information storage unit 14a. The information storage unit 14a is provided for a storage of at least one item of information about the placement unit 16a. At least one intrinsic placement unit characteristic of the placement unit 16a is storable in the information storage unit 14a.

The information unit 12a is designed to be arranged on the placement unit 16a outside of a heating region 22a of the placement unit 16a for the purpose of communicating with a communication unit 20a. The heating region 22a of the placement unit 16a is a base of the placement unit 16a. In the operating state, the placement unit 16a comes into contact with the cooking surface 18a at least in some portions by means of the base and/or by means of the heating region 22a.

For the purpose of communicating with the communication unit 20a, the information unit 12a is arranged spaced apart from the heating region 22a of the placement unit 16a and namely, in particular, at least relative to a direction oriented perpendicular to a main direction of extent of the placement plate 34a. Viewed perpendicular to a main extension plane of the placement plate 34a, the information unit 12a is arranged laterally adjacent to a region spanned by the heating region 22a and/or by the base.

The information unit 12a is provided for an arrangement on a side wall 24a of the placement unit 16a. In the operating state, the information unit 12a is arranged on the side wall 24a of the placement unit 16a and namely, in particular, so as to be releasable without the use of tools. In the operating state, the information unit 12a is arranged on the placement unit 16a.

For the arrangement on the side wall 24a of the placement unit 16a, in the operating state the information unit 12a has a concave design in some portions on a surface 26a facing the side wall 24 (see FIG. 4). In the operating state, the communication unit 20a is arranged in the vicinity of the information unit 12a.

The cooking system 30a has the communication unit 20a. In the operating state, the communication unit 20a surrounds the information unit 12a to a large extent. In the operating state, the communication unit 20a is arranged on the placement unit 16a outside of the heating region 22a of the placement unit 16a. In the present exemplary embodiment, in the operating state the communication unit 20a is arranged on the side wall 24a of the placement unit 16a.

For the arrangement on the side wall 24a of the placement unit 16a, in the operating state the communication unit 20a has a concave design in some portions on a surface facing the side wall 24a (see FIG. 4). In the operating state, the communication unit 20a is arranged on the placement unit 16a so as to be releasable without the use of tools. In the operating state, the communication unit 20a is provided for a releasable arrangement on the placement unit 16a without the use of tools.

The communication unit 20a is provided for communication with the information unit 12a. In the operating state, the communication unit 20a communicates with the information unit 12a. In the operating state, the communication unit 20a and the information unit 12a communicate by means of a near field communication technology.

The information unit 12a is provided for a communication with the communication unit 20a by means of a near field communication technology. In the operating state, the information unit 12a transmits to the communication unit 20a at least one placement unit characteristic of the placement unit 16a stored in the information storage unit 14a.

In the operating state, the communication unit 20a transmits at least one placement unit characteristic of the placement unit 16a to the information unit 12a and namely, in particular, for the purpose of a storage of the placement unit characteristic of the placement unit 16a in the information storage unit 14a of the information unit 12a.

The communication unit 20a has a user interface 42a. The user interface 42a is provided for an input and/or selection of at least one placement unit characteristic of the placement unit 16a. In the operating state, the communication unit 20a transmits to the information unit 12a at least one placement unit characteristic of the placement unit 16a which is input and/or selected by means of the user interface 42, in particular for the purpose of a storage of the placement unit characteristic of the placement unit 16a in the information storage unit 14a of the information unit 12a.

In the present exemplary embodiment, at least one intrinsic placement unit characteristic is stored in a predefined manner in the information storage unit 14a. In particular, in addition to the intrinsic placement unit characteristic stored in a predefined manner in the information storage unit 14a, the information unit 12a is provided for receiving at least one intrinsic placement unit characteristic from at least one further unit 28a for the purpose of storing the received placement unit characteristic in the information storage unit 14a.

The cooking system 30a has the further unit 28a. In the present exemplary embodiment, the further unit 28a is a mobile device. The mobile device in the present exemplary embodiment is a cell phone. Alternatively or additionally, the further unit 28a could be, in particular, at least partially integrally configured with the communication unit 20a and/or at least partially integrally configured with at least one mobile device which is, in particular, different from a cell phone and/or with at least one network (not shown).

At least one placement unit characteristic configured as a geometric characteristic is storable in the information storage unit 14a. In the operating state, at least one placement unit characteristic configured as a geometric characteristic is stored in the information storage unit 14a.

In particular, in addition to the placement unit characteristic configured as a geometric characteristic, at least one placement unit characteristic configured as a suitability characteristic is storable in the information storage unit 14a. In the operating state, at least one placement unit characteristic configured as a suitability characteristic is stored in the information storage unit 14a.

In a method for an operation of the cooking device 10a and/or the cooking system 30a, in particular of the cooking device 10a and of the cooking system 30a, in a storage step 44a at least one intrinsic placement unit characteristic is electronically stored and namely, in particular, in the information storage unit 14a of the information unit 12a (see FIG. 5).

At least one intrinsic placement unit characteristic is stored, in particular, chronologically before the storage step 44a in the information storage unit 14a of the information unit 12a and namely, in particular, in the factory and/or by a mechanic and/or by a technician.

In a communication step 46a, at least one intrinsic placement unit characteristic stored in the information storage unit 14a of the information unit 12a is transmitted and namely, in particular, from the information unit 12a to the communication unit 20a. In a preparation step 48a, at least one intrinsic placement unit characteristic is provided electronically and namely, in particular, from the information unit 12a and the communication unit 20a.

### REFERENCE NUMERALS

10 Cooking device
12 Information unit
14 Information storage unit
16 Placement unit
18 Cooking surface
20 Communication unit
22 Heating region
24 Side wall
26 Surface
28 Further unit
30 Cooking system
32 Hob
34 Placement plate
36 Hob user interface
38 Hob control unit
40 Hob heating unit
42 User interface
44 Storage step
46 Communication step
48 Preparation step

1-13. (canceled)

14. A cooking device, comprising an information unit including an information storage unit for storing an intrinsic placement unit characteristic of a placement unit which is placeable on a cooking surface so as to be heatable, said information unit being arranged on the placement unit outside of a heating region of the placement unit for communication with a communication unit.

15. The cooking device of claim 14, constructed in the form of an induction cooking device.

16. The cooking device of claim 14, wherein the information unit is releasably arranged on the placement unit without requiring use of a tool.

17. The cooking device of claim 14, wherein the information unit is arranged on a side wall of the placement unit.

18. The cooking device of claim 17, wherein the information unit has a surface which faces the side wall, said surface having in an operating state at least one portion of concave configuration.

19. The cooking device of claim 14, wherein the information unit communicates with the communication unit by a near field communication technology.

20. The cooking device of claim 14, wherein the intrinsic placement unit characteristic is stored in a predefined manner in the information storage unit.

21. The cooking device of claim 14, wherein the information unit is configured to receive an intrinsic placement unit characteristic from a further unit and to store the received placement unit characteristic in the information storage unit.

22. The cooking device of claim 14, wherein the placement unit characteristic is a geometric characteristic stored in the information storage unit.

23. The cooking device of claim 14, wherein the placement unit characteristic is a suitability characteristic stored in the information storage unit.

24. A cooking system, comprising:
a placement unit placeable on a cooking surface so as to be heatable; and
a cooking device comprising an information unit which includes an information storage unit for storing an intrinsic placement unit characteristic of the placement unit, said information unit being arranged in an operating state on the placement unit outside of a heating region of the placement unit.

25. The cooking system of claim 24, further comprising a communication unit arranged in the operating state on the placement unit outside of the heating region of the placement unit for communication with the information unit.

26. The cooking system of claim 25, wherein the communication unit is configured for a releasable arrangement on the placement unit without requiring use of a tool.

27. A method for operating a cooking device and/or a cooking system, said method comprising:
electronically transmitting to an information unit an intrinsic placement unit characteristic of a placement unit which is placeable on a cooking surface so as to be heatable; and
storing the intrinsic placement unit characteristic in an information storage unit of the information unit.

28. The method of claim 27, further comprising communicating the intrinsic placement unit characteristic between the information unit and a communication unit.

29. The method of claim 28, wherein the information unit communicates with the communication unit by a near field communication technology.

30. The method of claim 27, wherein the intrinsic placement unit characteristic is stored in a predefined manner in the information storage unit.

31. The method of claim 27, further comprising:
transmitting an intrinsic placement unit characteristic from a further unit to the information unit, and
storing the received placement unit characteristic in the information storage unit of the information unit.

32. The method of claim 27, wherein the placement unit characteristic is a geometric characteristic stored in the information storage unit.

33. The method of claim 27, wherein the placement unit characteristic is a suitability characteristic stored in the information storage unit.
